(19) United States
(12) Patent Application Publication
(10) Pub. No.: US 2012/0092362 A1
(43) Pub. Date: Apr. 19, 2012

(54) SYSTEM AND METHOD FOR DETECTING LIGHT INTENSITY IN AN ELECTRONIC DEVICE

(75) Inventors: CHIH-KUANG CHANG, Tu-Cheng (TW); XIAO-GUANG XUE, Shenzhen City (CN); ZHONG-KUI YUAN, Shenzhen City (CN); LI JIANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/037,121

(22) Filed: Feb. 28, 2011

(30) Foreign Application Priority Data
Oct. 15, 2010 (CN) 201010510000.8

(51) Int. Cl. G09G 5/02

(52) U.S. Cl. 345/604

(57) ABSTRACT

An electronic device and a method for testing the light intensity of the electronic device include setting a colorbar comprising a plurality of colors corresponding to different gray values. The testing method further includes read bitmap data of read image upon the condition that the read image is a gray image, and recording a pixel number corresponding to each gray value. The method further includes drawing a relationship curve between the plurality of gray values and corresponding pixel numbers and recoloring the gray image according to the plurality of colors in the colorbar corresponding to the gray values of each pixel in the gray image, and displaying the relationship curve and a recolored gray image on a display.

### BACKGROUND

1. Technical Field

Embodiments of the present disclosure relate to data detection, and in particular, to a system and method for detecting the light intensity in an electronic device.

2. Description of Related Art

Light source (e.g. coaxial light and ring light) is very important for image measurement using measuring instruments. If the light source is not bright enough, the measuring instruments may not display edges and surface of a workpiece clearly. If the light source is too bright, deformation errors may be generated. The measurement results of the measuring instruments may be influenced greatly by light intensity. Therefore, it is necessary to detect the light intensity to determine whether the light source is appropriate.

### BRIEF DESCRIPTION OF THE DRAWINGS

FIG. 1 is a schematic diagram of one embodiment of an electronic device including a detection system.

FIG. 2 is a block diagram of one embodiment of the detection system of FIG. 1.

FIG. 3 is a flowchart of one embodiment of a method for detecting light intensity in an electronic device, such as, that of FIG. 1.

FIG. 4 is a flowchart of one embodiment of a method for drawing a relationship curve in an electronic device, such as, that of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, for example, Java, C, or Assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage system.

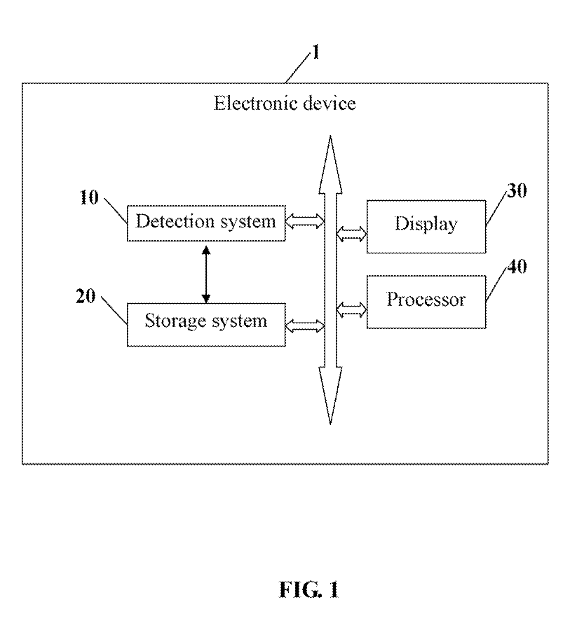

FIG. 1 is a schematic diagram of one embodiment of an electronic device 1 including a detection system 10. The electronic device 1 may be a desktop computer, a notebook computer, or a server. The electronic device 1 also includes a storage system 20 for storing images, such as gray images. The storage system 20 may be a memory of the electronic device 1, or an external storage card, such as a smart media (SM) card, or a secure digital (SD) card. The detection system 10 may detect gray values of the gray images in the storage system 20, and draw a relationship curve and a recolored image of the gray values, to represent light intensity.

The electronic device 1 further includes a display 30, and at least one processor 40. The display 30 may output visible data, such as the relationship curve and the recolored image. The at least one processor 40 executes one or more computerized codes of the electronic device 1 and other applications, to provide the functions of the detection system 10.

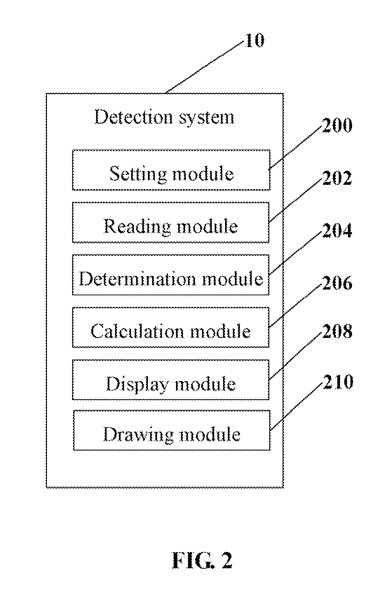

FIG. 2 is a block diagram of one embodiment of the detection system 10 of FIG. 1. In some embodiments, the detection system 10 includes a setting module 200, a reading module 202, a determination module 204, a calculation module 206, a display module 208, and a drawing module 210. The modules 200, 202, 204, 206, 208 and 210 comprise computerized code in the form of one or more programs that are stored in the storage system 20. The computerized code includes instructions that are executed by the at least one processor 40 to provide functions for modules 200, 202, 204, 206, 208 and 210. Details of these operations follow.

The setting module 200 sets a colorbar including a plurality of colors. The plurality of colors corresponds to different gray values. The setting module 200 pre-defines 256 colors in the colorbar, the 256 colors correspond to the gray values of 0-255. In some embodiments, the gray values represent the light intensity. For example, the gray value “0” may represent that the light intensity is minimum, and the gray value “0” corresponds to blue color. The gray value “255” may represent that the light intensity is maximum, and the gray value “255” corresponds to red color.

The read module 202 reads an image from the storage system 20.

The determination module 204 determines whether the read image is a gray image. In some embodiments, if a suffix name of the read image is “bmp”, the determination module 204 determines that the read image is a gray image.

If the read image is the gray image, the reading module 202 further reads bitmap data of the read image. The bitmap data may include, but is not limited to a total number of pixels of the read image and a gray value corresponding to each pixel. In some embodiments, different pixels may have a same gray value.

The calculation module 206 obtains a maximum gray value and a minimum gray value from the bitmap data, and calculates an average gray value of the read image by dividing a sum of the gray values corresponding to the pixels of the read image by the total numbers of the pixels.

The display module 208 displays the maximum gray value, the minimum gray value, and the average gray value on the display 30.

The drawing module 210 records a pixel number corresponding to each gray value, draws a relationship curve between the plurality of gray values and corresponding pixel numbers, and recolors the read image according to the plurality of colors in the colorbar corresponding to the gray value of each pixel in the read image. For example, pixel numbers of one gray value “0” may be 11845. In some embodiments, the drawing module 210 may draw an origin of the relationship curve according to a predetermined origin coordinates, and draw an x-axis (e.g. the gray values) and a y-axis (e.g. the pixel numbers corresponding to each gray value) of the relationship curve. The drawing module 210 further draws axis scales of the x-axis and the y-axis. The axis scales may be predetermined. For example, scales of the x-axis may be 15 gray values as one scale, and scales of the y-axis may be 11846 pixels as one scale. According to the plurality of gray values and corresponding pixel numbers, the drawing module 210 draws the relationship curve.

The display module 208 further displays the relationship curve and a recolored image on the display 30.

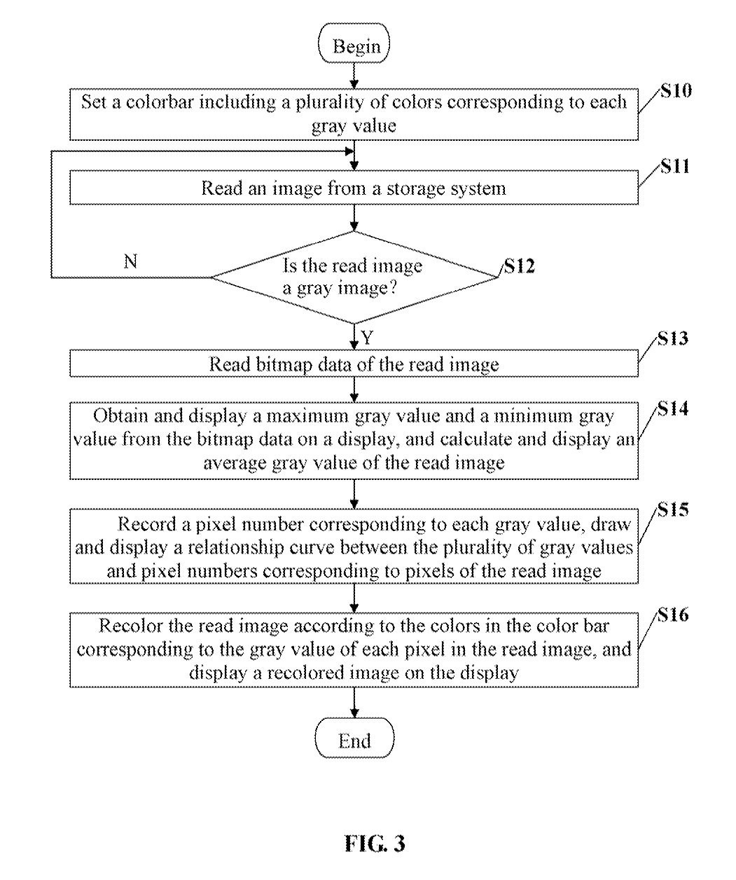

FIG. 3 is a flowchart of one embodiment of a method for detecting light intensity of an electronic device of FIG. 1. Depending on the embodiment, additional blocks may be added, others removed, and the ordering of the blocks be changed.

In block S10, the setting module 200 sets a colorbar including a plurality of colors, the plurality of colors corresponding to different gray values.

In block S11, the read module 202 reads an image from the storage system 20.

In block S12, the determination module 204 determines whether the read image is a gray image. In some embodiments, if a suffix name of the read image is “bmp”, the determination module 204 determines that the read image is a gray image.

If the read image is the gray image, in block S13, the reading module 202 reads bitmap data of the read image upon the condition that the read image is a gray image. The bitmap data may include, but is not limited to a total number of pixels of the read image and a gray value corresponding to each pixel. If the read image in not the gray image, block S11 is repeated.

In block S14, the calculation module 206 obtains a maximum gray value and a minimum gray value from the bitmap data, and calculate an average gray value of the read image by dividing a sum of the gray values corresponding to the pixels of the read image by the total numbers of the pixels. The displaying module 208 displays the maximum gray value, the minimum gray value and the average gray value.

In block S15, the drawing module 210 records a pixel number corresponding to each gray value, draws a relationship curve between the plurality of gray values and corresponding pixel numbers, and the display module 210 displays the relationship curve on the display 30.

In block S16, the drawing module 210 further recolors the read image according to the plurality of colors in the colorbar corresponding to the gray values of the pixels in the read image, and the display module 208 displays a recolored image on the display 30.

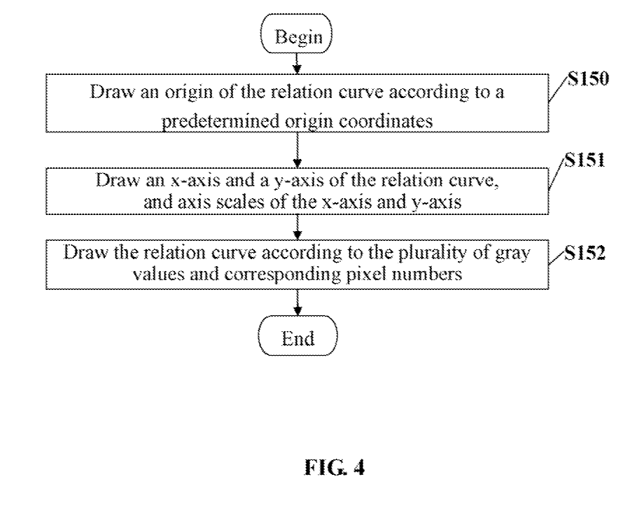

FIG. 4 is a flowchart of one embodiment of a method for drawing a relationship curve in an electronic device of FIG. 1.

In block S150, the drawing module 210 draws an origin of the relationship curve according to a predetermined origin coordinates.

In block S151, the drawing module 210 draws an x-axis and a y-axis of the relationship curve, and further draws axis scales of the x-axis and the y-axis.

In block S152, the drawing module 210 draws the relationship curve according to the plurality of gray values and corresponding pixel numbers.

It should be emphasized that the described exemplary embodiments are merely possible examples of implementations, and set forth for a clear understanding of the principles of the present disclosure. Many variations and modifications may be made to the-described exemplary embodiments without departing substantially from the spirit and principles of the present disclosure. All such modifications and variations are intended to be comprised herein within the scope of this disclosure and the-described inventive embodiments, and the present disclosure is protected by the following claims.

What is claimed is:

1. An electronic device, comprising:
a display;
a storage system for storing images;
at least one processor; and
one or more programs stored in the storage system, executable by the at least one processor, the one or more programs comprising:
a setting module operable to set a colorbar comprising a plurality of colors corresponding to different gray values;
a reading module operable to read an image from the storage system, and read bitmap data of the read image upon the condition that the read image is a gray image, the bitmap data comprising a total number of pixels of the read image and a gray value corresponding to each pixel;
a drawing module operable to record a pixel number corresponding to each gray value, draw a relationship curve between the plurality of gray values and corresponding pixel numbers, and recolor the read image according to the plurality of colors in the colorbar corresponding to the gray values of pixels in the read image;
a display module operable to display the relationship curve and a recolored image on the display.

2. The electronic device as claimed in claim 1, wherein the one or more programs further comprises:
a calculation module operable to obtain a maximum gray value and a minimum gray value from the bitmap data, and calculate an average gray value of the read image by dividing a sum of the gray values corresponding to the pixels by the total numbers of the pixels.

3. The electronic device as claimed in claim 2, wherein the display module is further operable to display the maximum gray value, the minimum gray value, and the average gray value on the display.

4. The electronic device as claimed in claim 2, wherein the drawing module draws the relationship curve by:
drawing an origin of the relationship curve according to a predetermined origin coordinates;
drawing an x-axis and a y-axis of the relationship curve, and drawing axis scales of the x-axis and the y-axis;
drawing the relationship curve according to the plurality of gray values and pixel numbers corresponding to each gray value.

5. The electronic device as claimed in claim 1, wherein a suffix name of the read image is “bmp”.

6. A computer-implemented method for detecting light intensity of an electronic device, the method comprising:
setting a colorbar comprising a plurality of colors corresponding to different gray values;
reading an image from the storage system, and reading bitmap data of the read image upon the condition that the read image is a gray image, the bitmap data comprising a total number of pixels of the read image and a gray value corresponding to each pixel;
recording a pixel number corresponding to each gray value, drawing a relationship curve between the plurality of gray values and corresponding pixel numbers, and recoloring the read image according to the plurality of colors in the colorbar corresponding to the gray values of pixels in the read image;
displaying the relationship curve and a recolored image on a display of the electronic device.

7. The method as claimed in claim 6, wherein the method further comprises:
obtaining a maximum gray value and a minimum gray value from the bitmap data; and
calculating an average gray value of the read image by dividing a sum of the gray values corresponding to the pixels by the total numbers of the pixels.

8. The method as claimed in claim 7, wherein the method further comprises displaying the maximum gray value, the minimum gray value and the average gray value on the display.

9. The method as claimed in claim 7, wherein drawing the relationship curve is by drawing an origin of the relationship curve according to a predetermined origin coordinates;
drawing a x-axis and a y-axis of the relationship curve, and drawing axis scales of the x-axis and the y-axis; and
drawing the relationship curve according to the plurality of gray values and pixel numbers corresponding to each gray value.

10. The method as claimed in claim 6, wherein a suffix name of the read image is “bmp”.

11. A storage medium storing a set of instructions, the set of instructions capable of executed by a processor to perform a method for detecting light intensity of an electronic device, the method comprising:
setting a colorbar comprising a plurality of colors corresponding to different gray values;
reading an image from the storage system, and reading bitmap data of the read image upon the condition that the read image is a gray image, the bitmap data comprising a total number of pixels of the read image and a gray value corresponding to each pixel;
recording a pixel number corresponding to each gray value, drawing a relationship curve between the plurality of gray values and corresponding pixel numbers, and recoloring the read image according to the plurality of colors in the colorbar corresponding to gray values of pixels in the read image;
displaying the relationship curve and a recolored image on a display of the electronic device.

12. The storage medium as claimed in claim 11, wherein the method further comprises:
obtaining a maximum gray value and a minimum gray value from the bitmap data; and
calculating an average gray value of the read image by dividing a sum of the gray values corresponding to the pixels by the total numbers of the pixels.

13. The storage medium as claimed in claim 12, wherein the method further comprises displaying the maximum gray value, the minimum gray value and the average gray value on the display.

14. The storage medium as claimed in claim 12, wherein drawing the relationship curve is by drawing an origin of the relationship curve according to a predetermined origin coordinates;
drawing a x-axis and a y-axis of the relationship curve, and drawing axis scales of the x-axis and the y-axis; and
drawing the relationship curve according to the plurality of gray values and pixel numbers corresponding to each gray value.

15. The storage medium as claimed in claim 11, wherein a suffix name of the read image is “bmp”.
